(19) United States
(12) Patent Application Publication
(10) Pub. No.: US 2009/0200808 A1
(43) Pub. Date: Aug. 13, 2009

(54) POLE-MOUNTABLE WIND TURBINE SUPPORT SYSTEM

(76) Inventor: Daniel W. Parmley, SR., Phoenix, AZ (US)

Correspondence Address: KEITH L. JENKINS, 2222 NORTH MCQUEEN ROAD #2069, CHANDLER, AZ, 85225, US

(21) Appl. No.: 12/409,476

(22) Filed: Mar. 23, 2009

Related U.S. Application Data
(63) Continuation-in-part of application No. 12/124,883, filed on May 21, 2008.
Application No. 12/124,883 is a continuation-in-part of application No. 11/361,490, filed on Feb. 25, 2006, now Pat. No. 7,411,308.
(60) Provisional application No. 61/038,776, filed on Mar. 23, 2008.

(51) Int. Cl. F03D 9/00; H02J 1/10

(52) U.S. Cl. 290/55; 307/43

(57) ABSTRACT

A support for supporting a plurality of wind turbine generators on a pole may be raised or lowered. The support accommodates a solar voltaic array attached to the pole and allows the wind turbines to be raised and lowered past the attached solar voltaic array. Waste heat from the solar voltaic array is ducted to assist in driving the wind turbines. A cogeneration unit, including an engine-generator set, may be attached to the pole at the base and engine exhaust, heat exchanged to the air from the engine coolant, and convection-heated air from the engine-generator set may also be ducted to assist in driving the wind turbines. A reverse feed switch may be used to transfer excess electrical power to the commercial grid when the primary load does not require it. Loads may include a solar parking lot at night, a commercial building, or hospital.

### RELATED APPLICATIONS

The present application claims the benefit of Provisional Patent Application Ser. No. 61/038,776, filed by the present inventor on Mar. 23, 2008 for a POLE-MOUNTABLE WIND TURBINE SUPPORT SYSTEM. The present application is a continuation in part of co-pending Utility patent application Ser. No. 12/124,883 to the same inventor for RENEWABLE ENERGY POWER SYSTEMS, which is a continuation-in-part of Utility patent application Ser. No. 11/361,490, filed Feb. 25, 2006, now U.S. Pat. No. 7,411,308.

### FIELD OF THE INVENTION

The present invention relates to support systems for mounting vertical axis wind turbines (VAWTs) on poles or other vertical structures. It more particularly relates to mounting two vertical axis wind turbines symmetrically on a structure astride a vertical pole, wherein the structure has a rotational degree of freedom about the pole to provide equal wind velocities for each wind turbine and a translational degree of freedom to move up and down the pole. The present invention also relates to applications for such a device.

### BACKGROUND OF THE INVENTION

Many commercial power consumers, such as hospitals and computer facilities need sources of electrical power that are independent from the commercial electrical grid, either for producing a higher quality (less ripple and noise) electrical power or as a backup. Cogeneration units are often used for this purpose. Cogeneration units include engine-generator sets to provide electricity and hot water or steam, as known in the art. The hot water or steam may be used to heat buildings, as the electricity supplies power to those same buildings.

With the world at the beginning of the end of the carbon-fuel age, innovative approaches are needed to combine various renewable, or “green” energy sources to replace carbon-based fuels and their pollutant oxides of carbon. Non-polluting energy sources such as wind, solar, hydro, and geothermal energy sources must fully exploited to maintain a breathable atmosphere. In the field of wind turbines, vertical axis wind turbines have evolved from the Savonius rotor configuration through the Darrieus design and to the Gorlov helical turbine and the giromill designs. As a result, VAWTs have become commercially feasible. Methods of exploiting these devices are needed.

An exemplary opportunity for fuel conservation is in thermal control of parking for motor vehicles. A car parked in broad summer daylight in Phoenix, Ariz. may reach an internal temperature of 160 degrees Fahrenheit. To enable humans to occupy the vehicle, the temperature must be significantly reduced by the automobile's air conditioning unit, which consumes fuel. Not only the air inside the vehicle must be cooled, but the material of which the vehicle interior is made must be cooled down. A vehicle under shaded parking on the same Arizona summer day will reach the ambient temperature of 110 degrees Fahrenheit, requiring significantly less fuel to cool down the vehicle to an inhabitable temperature. In Northern tier states, winter weather can cool down an exposed vehicle to an uninhabitable temperature, and fuel must be consumed to heat it back up. In covered parking, the temperature is moderated, and less fuel is consumed.

Traditional engine-generator sets (“gensets”) produce extensive amounts of waste heat that is conventionally rejected through an air-cooled heat exchanger, or radiator. Larger commercial gensets have fans to drive the cooling air at high flow rates. The waste heat and the kinetic energy of the flowing air are normally wasted, as conventional heat exchangers needed to recapture the waste heat are generally considered commercially unfeasible. Solar voltaic arrays also generate substantial amounts of waste heat, with approximately 60% of the waste heat lost off the front surface of the array and 40% of the waste heat lost off the back plane of the array.

The present inventor has recognized a need for cogeneration systems that economically convert waste heat into electrical power.

To meet the above-mentioned needs, to solve the above-mentioned problems, and to improve upon the above-mentioned systems, applicant presents what follows.

### BRIEF SUMMARY OF THE INVENTION

A pole-mountable wind turbine support system including: a plurality of wind turbines; a support, able to support the plurality of wind turbines on a vertical pole, where at least a portion of the support is further able to raise and lower the plurality of wind turbines on the vertical pole. The pole-mountable wind turbine support system further includes a plurality of electrical generators, corresponding to the plurality of wind turbines, coupled to the plurality of wind turbines and able to produce electricity responsive to rotation of wind turbine of the plurality of wind turbines. The pole-mountable wind turbine support system where the support includes a support ring, where the support ring includes first and second half-rings able to be releasably fastened to form the support ring. The pole-mountable wind turbine support system where the first half-ring has a fixed vertical position on the pole and has rotational freedom of motion about a vertical axis of the pole. The second half-ring is able to move vertically on the pole and move the plurality of pole-mountable wind turbines rotationally about the pole, responsive to changes in wind direction.

The pole-mountable wind turbine support system further includes a solar voltaic array fixed to a first side of the pole; ductwork for directing air bearing waste heat from the solar voltaic array, where the air bearing the waste heat is ducted to assist in driving the plurality of wind turbines; where the second half-ring is able to move the plurality of wind turbines above or below the solar voltaic array on a second side of the pole. The pole-mountable wind turbine support system further includes vertical actuators able to move at least a portion of the support vertically on the pole. The pole-mountable wind turbine support system further includes an engine-generator set for producing electricity and heat, where the heat includes heat from an engine cooling system, heat from engine exhaust gases, and heat from convection cooling of the engine generator set; a heat exchanger for transferring at least a portion of the heat to an air stream; and ductwork for directing the heated airstream to drive the plurality of wind turbines. The pole-mountable wind turbine support system further includes a solar voltaic array fixed to a first side of the pole; ductwork for directing air bearing waste heat from the solar voltaic array, where the air bearing the waste heat is ducted to assist in driving the plurality of wind turbines; where the second half-ring is able to move the plurality of wind turbines above or below the voltaic array on a second side of the pole.

The pole-mountable wind turbine support system where electric power from the engine-generator set, electric power from the solar voltaic array, and electric power from the plurality of wind turbines is combined on a common DC bus in a UPS, where the DC bus has a DC output coupling. The pole-mountable wind turbine support system where the combined electrical power is provided to a reverse feed switch and to a primary load, where the reverse feed switch is able to transfer at least a portion of the combined electrical power to a commercial electrical power grid when the primary load does not consume all of the combined electrical power. The pole-mountable wind turbine support system where the reverse feed switch includes a portion of parking lot solar power system, the parking lot solar power system further including: a parking lot; a roof for providing shaded parking for vehicle, the roof supported above at least a portion of the parking lot; solar voltaic array mounted on the roof, a housing able to support and assist in protecting: a UPS core having an AC input, an AC-DC converter, a multi-port DC bus, and a DC-AC inverter; the reverse feed switch electrically coupled to the DC-AC inverter and to the commercial electrical power grid; a backup AC generator electrically coupled to the primary load and to the reverse feed switch; and rapidly responsive energy storage device coupled to the multi-port DC bus; a power conduit from the solar voltaic array to an external DC input coupling on the multi-port DC bus; and a power conduit from an external DC output coupling on the multi-port DC bus, able to assist in coupling the multi-port DC bus to the automotive charging station.

A pole-mountable wind turbine support system including: a plurality of wind turbines mechanically coupled to a corresponding plurality of electrical power generators; a support, able to support the plurality of wind turbines on a vertical pole, the support including a ring surrounding the pole, the ring further including first and second half-rings that are releasably connectable together; and where the first half-ring maintains a fixed vertical position on the pole and is rotatable about a vertical axis of the vertical pole; and second half-ring is able to raise and lower the plurality of wind turbines on the vertical pole and, when connected to the first ring, is rotatable about the vertical axis of the vertical pole. The pole-mountable wind turbine support system further includes a plurality of additional electrical energy producers coupled to the pole; a heat exchanger for exchanging waste heat from the additional electrical energy producers to an air stream; and ductwork, able to conduct the heated air stream to assist in driving the plurality of wind turbines. The pole-mountable wind turbine support system further includes a UPS having a multi-port DC bus able to combine electrical power from the plurality of electrical energy producers and to provide a DC output coupling; a plurality of electrical loads coupled to the combined electrical power; a reverse feed switch able to provide combined electrical power to a commercial electrical power grid when other electrical loads do not require it. The pole-mountable wind turbine support system where an electrical load of the plurality of electrical loads includes a parking lot solar power system acting as an electrical load when solar power is not available. The pole-mountable wind turbine support system where the plurality of electrical energy producers includes a solar voltaic array and an engine-generator set. The pole-mountable wind turbine support system further includes an aerodynamic structure to assist in maintaining the plurality of wind turbines in air flows of approximately equal velocity. The pole-mountable wind turbine support system where the plurality of wind turbines includes first and second vertical-axis wind turbines having opposite rotational directions.

A pole-mountable wind turbine support system including: first and second vertical-axis wind turbines mechanically coupled to corresponding first and second electrical power generators; a support, able to support the first and second wind turbines astride a vertical pole, the support including a ring surrounding the pole, the ring further including first and second half-rings that are releasably connectable together, where: the first half-ring maintains a fixed vertical position on the pole and is rotatable about a vertical axis of the vertical pole; and second half-ring is able to raise and lower the plurality of wind turbines on the vertical pole and, when connected to the first ring, is rotatable about the vertical axis of the vertical pole; ductwork able to conduct a stream of heated air to assist in driving the first and second wind turbines; a heat exchanger able to heat the stream of heated air from waste heat generated by electrical power source; and a UPS having a multiport bus able to combine electrical power from the electrical power source with electrical power generated by the electrical power generators mechanically coupled to the first and second wind turbines.

### BRIEF DESCRIPTION OF THE DRAWING

The above and other objects and advantages of the present invention will become more apparent from the following description taken in conjunction with the following drawing in which:

FIG. 1A is an elevation view illustrating an exemplary embodiment of a pole-mountable wind turbine support system according to the present invention and showing a cross section line A-A′;

FIG. 1B is a top sectional view through section A-A′ illustrating the exemplary embodiment of the pole-mountable wind turbine support system according to the present invention and as shown in FIG. 1A;

FIG. 2 is a diagrammatic representation illustrating an exemplary embodiment of a solar parking lot with a hybrid co-generation energy tower incorporating the renewable energy power systems of FIG. 1, according to the present invention;

FIG. 3 is a side elevation view illustrating an exemplary embodiment of a detail of the hybrid co-generation energy tower of FIG. 2B, according to the present invention;

FIG. 4 is a top plan view illustrating an exemplary embodiment of a detail of the hybrid co-generation energy tower of FIG. 2B, according to the present invention;

FIG. 5 is a front elevation view illustrating an exemplary embodiment of a detail of the hybrid co-generation energy tower of FIG. 2B and FIG. 4, according to the present invention;

FIG. 6 is a top plan view illustrating an exemplary embodiment of a detail of the hybrid co-generation energy tower of FIG. 5, according to the present invention;

FIG. 7 is a side elevation view illustrating an exemplary embodiment of a detail of the hybrid co-generation energy tower of FIG. 2B, according to the present invention;

FIG. 8 is a top plan view illustrating an exemplary embodiment of a detail of the hybrid co-generation energy tower of FIG. 2B, according to the present invention;

FIG. 9 is a front elevation view illustrating an exemplary embodiment of a detail of the hybrid co-generation energy tower of FIG. 2B, according to the present invention;

FIG. 10 is a top plan view illustrating an exemplary embodiment of a detail of the hybrid co-generation energy tower of FIG. 2B, according to the present invention;

FIG. 11 is a side elevation view illustrating an exemplary embodiment of a detail of the hybrid co-generation energy tower of FIG. 2B, according to the present invention;

FIG. 12 is a top plan view illustrating an exemplary embodiment of a detail of the hybrid co-generation energy tower of FIG. 2B, according to the present invention;

FIG. 13 is a side elevation view illustrating an exemplary embodiment of a detail of the hybrid co-generation energy tower of FIG. 2B, according to the present invention;

FIG. 14 is a side elevation cutaway view illustrating another exemplary embodiment of a detail of a hybrid co-generation energy tower, incorporating essential features of the renewable energy power systems of FIG. 1, according to the present invention; and

FIG. 15 is a side elevation cutaway view further illustrating the exemplary embodiment of details of a hybrid co-generation energy tower of FIG. 14, according to the present invention.

### DETAILED DESCRIPTION OF THE DRAWING

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

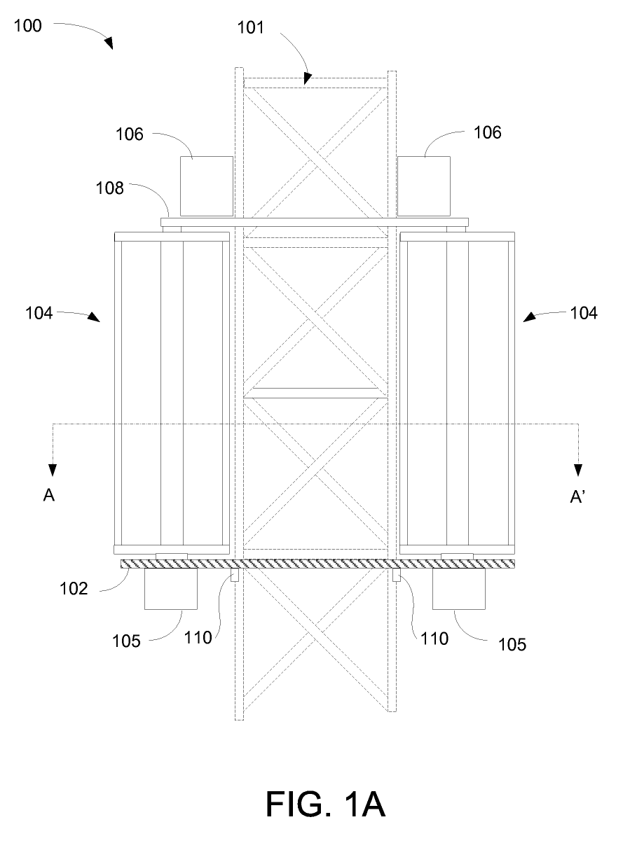

FIG. 1A is an elevation view illustrating an exemplary embodiment of the pole-mountable wind turbine support system 100 according to the present invention and showing a cross section line A-A′. Pole-mountable wind turbine support system 100 is shown on pole 101 (shown as a box-beam truss). Support ring 102 may be annular and surrounds pole 101. Guides 110 are rotationally slidingly engaged to support ring 102 and are shaped to translationally slidingly engage the pole 101. Accordingly, support ring 102 may rotate about the axis of the pole. The support ring 102 need not be a monolithic structure, but should be designed to minimize weight, consistent with meeting design loads. While two vertical axis wind turbines (“VAWTs”) 104 are shown, in an alternate embodiment, more than two VAWTs 104 may be used. Preferably, to minimize net torque on the support structure 100, the two VAWTs 104 rotate in opposite directions.

Support ring 102 supports VAWTs 104 symmetrically about the pole 101. Upper support ring 108 supports the upper ends of the VAWTs 104. Preferably, upper support ring 108 and support ring 102 are rigidly coupled together. VAWTs 104 provide rotational mechanical energy to generators 105, which in turn produce electricity.

Vertical actuators 106 are operable to raise and lower the pole-mountable wind turbine support system 100 and the VAWTs 104 on the pole 101. While existing poles 101 are preferred, custom poles 101 for use with pole-mountable wind turbine support system 100 are within the scope of the present invention, as are modifications to existing poles 101. The advantage of the ability to raise and lower the pole-mountable wind turbine support system 100 is not only for maintenance, which is extremely difficult on many wind turbine installations. When the pole-mountable wind turbine support system 100 is used on a dual-use pole 101, it may be advantageous to lower the pole-mountable wind turbine support system 100 during the alternative use for the pole 101. For example, cargo cranes at major seaports are built with significant structural margins to deal with the variations in loads arising from various cargo weights and winds. When the crane is not operating, the structural margin of the crane support structure may be exploited by raising the pole-mountable wind turbine support system 100 and generating electricity. When the crane is in operation, the pole-mountable wind turbine support system 100 may be lowered to minimize the loading on the crane structure.

Vertical actuators 106 are preferably of the right-angle drive type, to avoid back-forces into the vertical actuator 106 and to ensure security of the system if the vertical actuators 106 fail. Other types of mechanical drives, known in the art to not transmit back-forces to the vertical actuators 106, may also be used.

Pole 101 may be, for example and without limitation, a crane, a bridge support, a building, or a pole 101 on which horizontal-axis propeller-type wind turbines are no longer being used. The pole 101 may be of any cross sectional shape, as adaptations to various cross-sectional shapes are within the scope of the present invention.

The exemplary example pole-mountable wind turbine support system 100 show two VAWTS 104. In some alternate embodiments, more than two VAWTs 104 may be used.

Section A-A′ defines a cross section for FIG. 1B.

FIG. 1B is a top sectional view through section A-A′ illustrating the exemplary embodiment of the pole-mountable wind turbine support system 100 according to the present invention and as shown in FIG. 1A. Support ring 102 is shown as annular, but may have an outside perimeter that is not circular, consistent with providing sufficient support to VAWTs 104.

A control system may be used to keep the VAWTs 104 facing winds of equal velocity. Such a control system may be as simple as a vane or other aerodynamic structure, such as a vane on a traditional farm water-pump windmill, or as complex as having upstream air speed sensors coupled to a modern electronic controller that signals a rotational actuator to position the support ring 102 in the correct rotational state.

Complete 360-degree rotation for the pole-mountable wind turbine support system 100 is not required. For example, implementations on bridge supports in which the pole-mountable wind turbine support system 100 has less than 180 degrees of rotational freedom are within the scope of the invention.

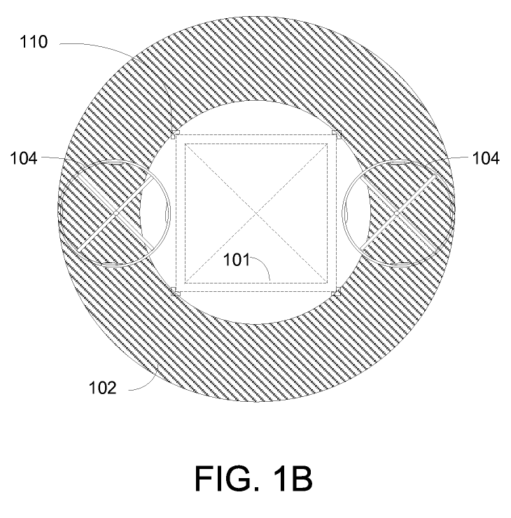

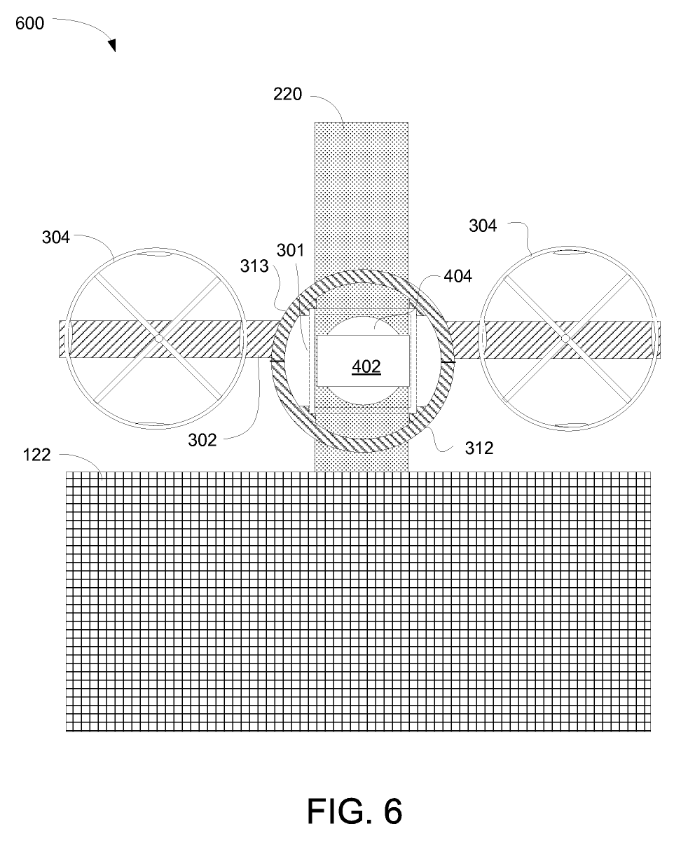

FIG. 2 is a diagrammatic representation illustrating an exemplary embodiment of a solar parking lot 200 with a hybrid co-generation energy tower 700 incorporating the pole-mountable wind turbine support system 100 of FIGS. 1A, 1B, and 7, according to the present invention. Housing 208 preferably supports and protects a UPS core 214, such as that disclosed in co-pending Utility patent application Ser. No. 12/124,883 to the same inventor for RENEWABLE ENERGY POWER SYSTEMS, a backup generator (not shown), a reverse feed switch 114, and associated cabling and wiring. Housing 208 is preferably located in a parking lot 202 and is preferably sized to take up only one parking space. In some embodiments, housing 208 is an ISO container. Housing 208 may also partially support roof 204, which is also supported by supports 210. Roof 204 and supports 210 may be of types known in the art of covered parking, or may be of novel design. Preferably, supports 210 and roof 204 have channels for wiring. Roof 204 provides shade 203 over a portion of parking lot 202 and also supports solar voltaic array 206. Solar voltaic array 206 may be horizontally disposed on top of roof 204, as shown, or may be inclined, preferably at an angle approximately equal to the latitude of the parking lot location to improve energy collection. The electrical output of the solar voltaic array 206 is electrically coupled via an electrical power conduit to an external DC input coupling of the multi-port bus of UPS core 214 which is located inside housing 208. Utility power 112 is conducted to the reverse feed switch 114 inside housing 208 via line 111, and then to the primary AC input of the UPS core 214 via line 115.

One automotive charging station 212 is preferably attached to every support 210. Each automotive charging station 212 preferably includes a plurality of DC outlets, each at a unique commercially useful voltage and each representing one external DC load to UPS core 214. While most electric and hybrid electric vehicles in service today are designed to be charged with AC power, that AC is run through a rectifier in the car to change it to DC for charging the batteries in the car. By providing regulated DC power directly, and at the voltages in commercial use, the conversion step inside the car, and associated waste, may be avoided. Each automotive charging station 212 preferably also includes an AC outlet for plugging in cars that can only be charged on AC. Each DC outlet and the AC outlet is uniquely configured so that the wrong plug cannot be accidentally inserted. The AC supplying the outlet is preferably the output AC power from the UPS core 214. The generator (not shown) is preferably configured to supply power to the input of the UPS core 214, in order to support external DC loads when utility power 112 fails. Electrical power conduits from DC output couplings of the multi-port bus of the UPS core 214 supply the DC outlets in the charging stations 212.

Primary load 118 is supplied from the output of the UPS core 214 inside housing 208 via line 117. Responsive energy storage means, such as a bank of ultra-capacitors in housing 208, maintains a constant output power level during intermittent solar energy supply and DC and AC demand.

The genset (engine-generator set) housing 220 contains and supports an engine-generator set for generating AC power. The engine of the genset preferably runs on hydrogen gas. The waste heat from the engine is transferred to air that is driven up through a ductwork inside the tower and directed onto two vertical wind turbines. The driving force behind the waste-heated air is a cooling fan blowing over a heat exchanger. The AC output of the genset may be routed directly to the primary load 118 via power conduit 119 or may be directed to the reverse feed switch 114 via power conduit 176. In this configuration, the genset is operating as a generator.

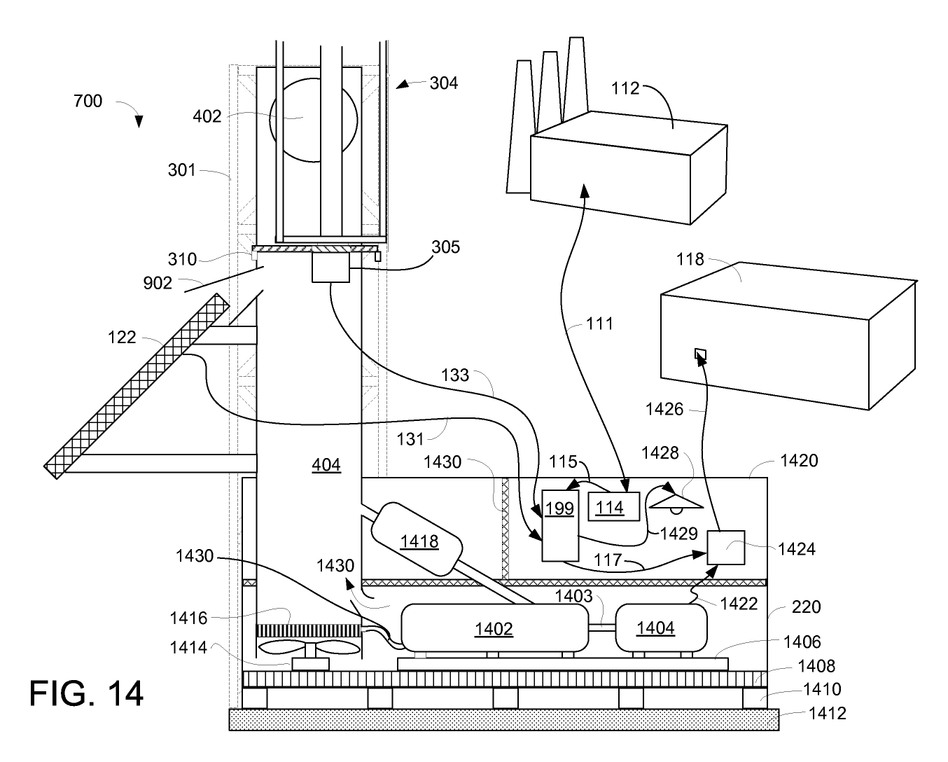

In a preferred embodiment, the genset housing 220 also contains a UPS core and a responsive energy storage device, forming a UPS 199 (see FIG. 14), and the genset AC output is coupled into the UPS core through a reverse feed switch 114 in place of the utility power 112. DC power from solar array 122 and wind turbines 304 is coupled into DC source ports on the UPS 199 in the genset housing 220. The AC output of the UPS 199 in the genset housing, created with the combined power from power producers genset AC power, solar array 122 DC power, and wind turbine 304 DC power, which is provided to a reverse feed switch 114 as primary power, and is coupled to second UPS core 214 in housing 208. Reverse feed switch 114 transfers excess power to the commercial electrical power grid when the primary load does not require all the power being produced. The DC power from solar voltaic array 206 is fed into the multi-port DC bus of UPS 214 and adds to the power available from UPS 214. The UPS 214 in housing 208 has external DC couplings to external DC loads, namely, the automotive recharging stations 212. The UPS 199 in the genset housing 220 has an external DC load, namely the cooling fan 1414. The AC output from the UPS 214 in housing 208 is conducted to primary load 118 via power conduit 117.

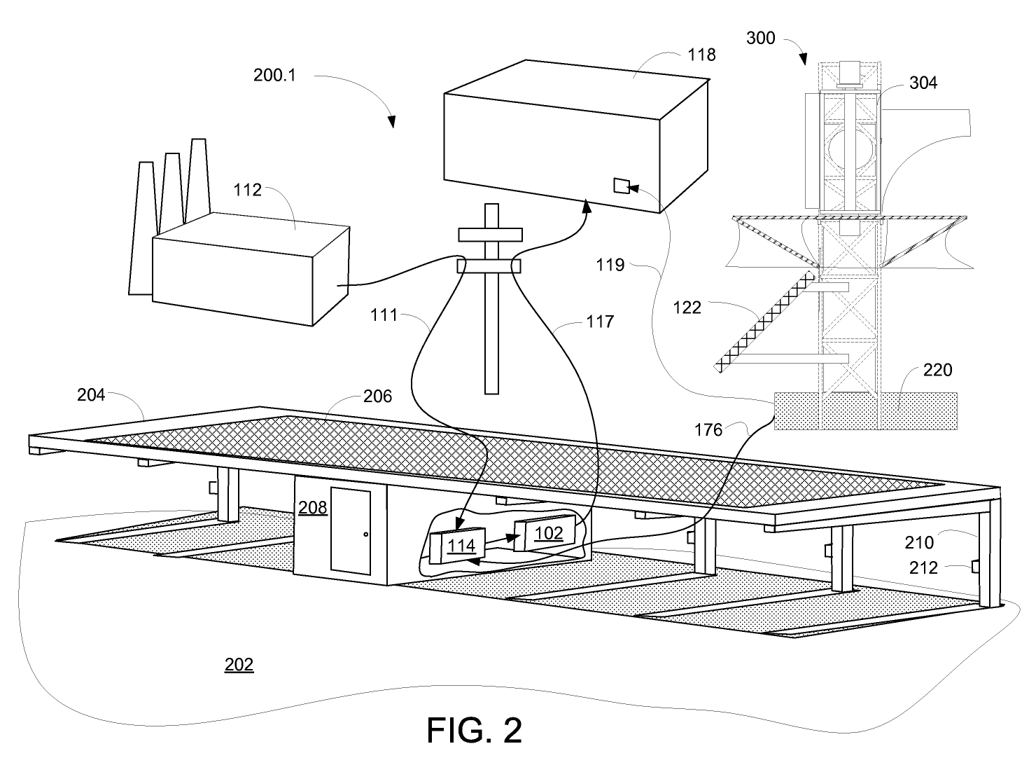

FIG. 3 is a side elevation view illustrating an exemplary embodiment of a detail of the hybrid co-generation energy tower 300 of FIGS. 2, 7, and 14, according to the present invention and defines section A-A′. Pole-mountable wind turbine support system 300 is shown on pole 301 (shown as a box-beam truss). Support ring 312-313 may be annular and surrounds pole 301. Guides 310 are rotationally slidingly engaged to support ring 302 and are shaped to translationally slidingly engage the pole 301. Accordingly, support ring 312-313 may rotate about the axis of the pole 301. The support ring 312-313 is preferably not a monolithic structure, but should be designed to minimize weight, consistent with meeting design loads. Support beams 302 extend from second half-ring 313 to support the VAWTs 304.

Support beam 302 supports VAWTs 304 symmetrically about the pole 301. Upper support ring 308 supports the upper ends of the VAWTs 304. Preferably, upper support ring 308 is also a split ring made of two half-rings. The first half of upper support ring 308 is preferably rigidly coupled to first half-ring 312 and the second half of upper support ring 308 (not visible in this view) is preferably rigidly coupled to second half-ring 313. VAWTs 304 provide rotational mechanical energy to generators 305, which in turn produce DC power.

Vertical actuators 306 are operable to raise or lower the pole-mountable wind turbine support system 300 on the pole 301. While existing poles 301 are preferred, custom poles 301 for use with pole-mountable wind turbine support system 300 are within the scope of the present invention, as are modifications to existing poles 301. The advantage of the ability to raise and lower the pole-mountable wind turbine support system 300 is not only for maintenance, which is extremely difficult on many wind turbine installations. When the pole-mountable wind turbine support system 300 is used on a dual-use pole 301, it may be advantageous to lower the pole-mountable wind turbine support system 300 during the alternative use for the pole 301. For example, cargo cranes at major seaports are built with significant structural margins to deal with the variations in loads arising from various cargo weights and winds. When the crane is not operating, the structural margin of the crane support structure may be exploited by raising the pole-mountable wind turbine support system 300 and generating electricity. When the crane is in operation, the pole-mountable wind turbine support system 300 may be lowered to minimize the loading on the crane structure.

Vertical actuators 306 are preferably of the right-angle drive type, to avoid back-forces into the vertical actuator 306 and to ensure security of the system if the vertical actuators 306 fail. Other types of mechanical drives, known in the art to not transmit back-forces to the vertical actuators 306, may also be used.

Pole 301 may be, for example and without limitation, a crane, a bridge support, a building, or a pole 301 on which horizontal-axis propeller-type wind turbines are no longer being used. The pole 301 may be of any cross sectional shape, as adaptations to various cross-sectional shapes are within the scope of the present invention. The exemplary example pole-mountable wind turbine support system 300 shows two VAWTS 304. In some alternate embodiments, more than two VAWTs 304 may be used.

Solar voltaic array 122 is also mounted on pole 301 using supports 315 that link to a half-ring which permits the solar array 180 degrees of rotational motion about the pole 301. The motion is preferably controlled by a motor controlled with a timer (not shown).

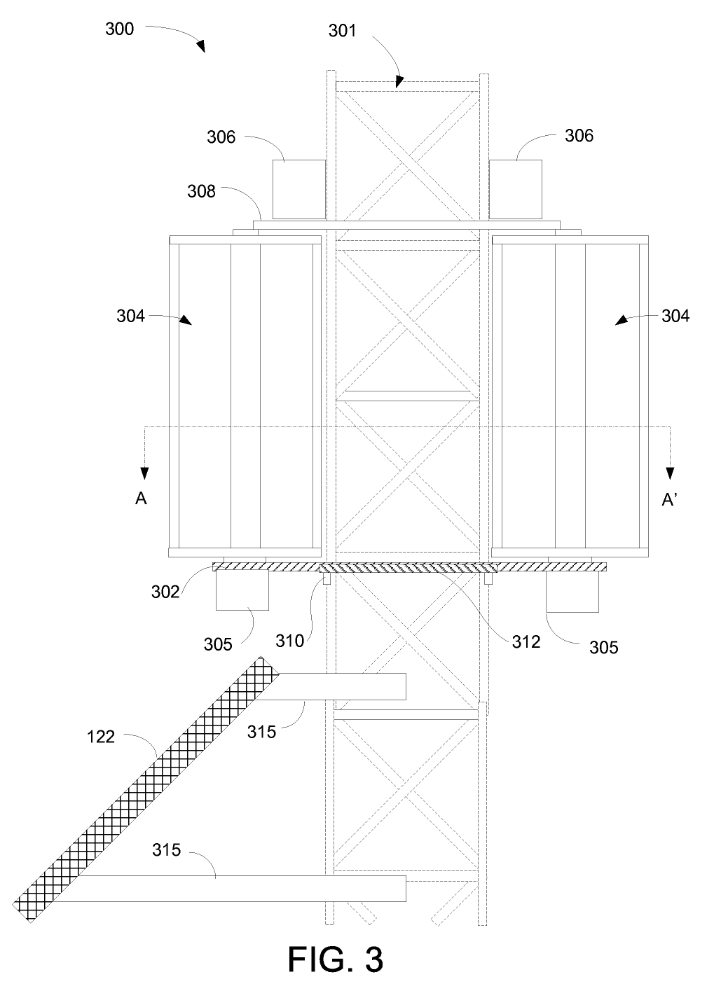

FIG. 4 is a top cross-sectional view A-A′ illustrating an exemplary embodiment of a detail 400 of the hybrid co-generation energy tower 700 of FIG. 2, according to the present invention. First half ring 312 is vertically fixed in position but has freedom of rotational motion about the vertical axis of the pole 301. Second half-ring 313 and first half-ring 312 are releasably connectable together to form an entire support ring such as support ring 102. VAWTs 304 are supported by beams 302 which are rigidly attached to second half-ring 313 of a split ring 312-313. The split ring 312-313 allows 360 degrees rotation about the pole 301 when the VAWTs 304 are raised to an operational position and half-rings 312-313 are connected. Second half-ring 313 can move vertically on the pole 301 to permit the VAWTs 304 to be lowered for maintenance and raised for operations.

Genset housing 220 produces, among other things, a waste-heat air stream that is driven up ductwork 404 and diverted by vents 402 to drive VAWTs 304. The waste heat may include engine exhaust, heat rejected by the engine coolant system, and heat transferred by convection off the engine-generator set within genset housing 220.

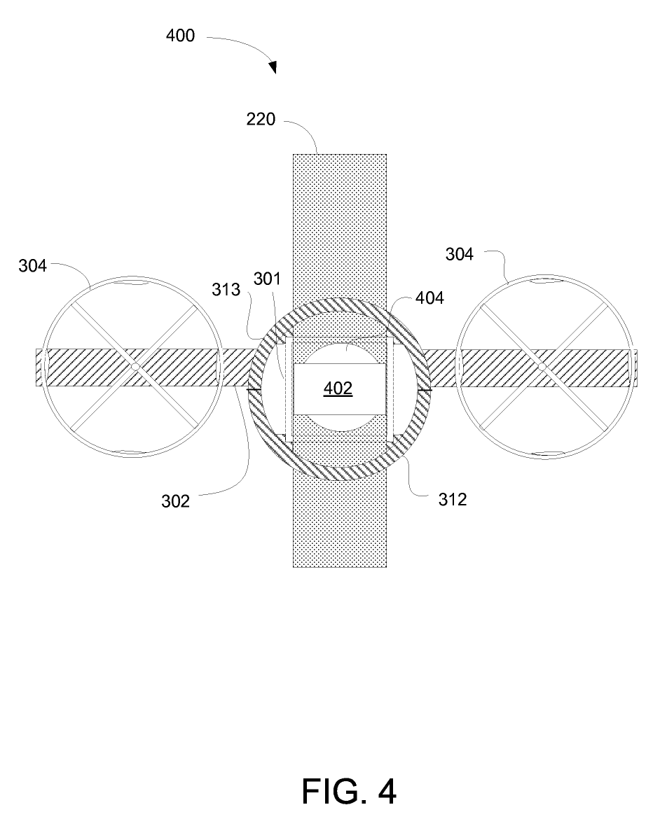

FIG. 5 is a front elevation view illustrating an exemplary embodiment of a detail 500 of the hybrid co-generation energy tower 700 of FIGS. 2, 7, and 14, according to the present invention. Hybrid co-generation energy tower 700 uses pole-mountable wind turbine support system 300 to extract waste heat from the solar-voltaic array 122 and genset housing 220. The width of the solar voltaic array 122 should not be significantly greater that the span of the VAWTs 304.

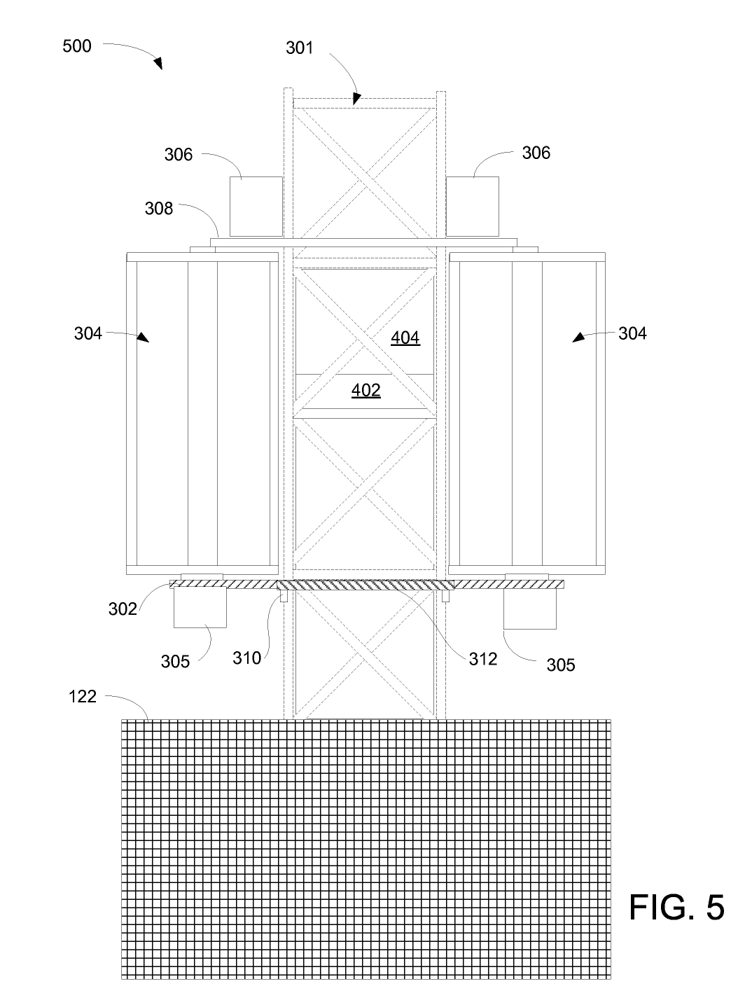

FIG. 6 is a top cross-sectional plan view illustrating an exemplary embodiment of a detail 600 of the hybrid co-generation energy tower 700 of FIG. 5, according to the present invention. In comparing FIG. 4 and FIG. 6, it can be seen that the VAWTs 304 may be used with or without a solar voltaic array 122. The front and back surfaces of solar voltaic array 122 exchange heat with the ambient air. In this embodiment, waste heat from the solar voltaic array rises from the front and rear surfaces of the solar voltaic array 122 and the slope of the solar voltaic array 122 imparts a useful horizontal component of velocity to assist in driving the VAWTs 304.

FIG. 7 is a side elevation view illustrating an exemplary embodiment of the hybrid co-generation energy tower 700 of FIG. 2, according to the present invention. Hybrid co-generation energy tower 700 uses pole-mountable wind turbine support system 300 to extract waste heat from the solar-voltaic array 122 and genset 220. Genset housing 220 is approximately 8 feet tall, and the solar voltaic array 122 is preferably operated at a height sufficient to allow trucks to park underneath it. Solar voltaic array 122 is preferably fixed to a first side of pole 301, to permit second half-ring 312 to pass the solar voltaic array 122 on the second side of pole 301 when being raised or lowered.

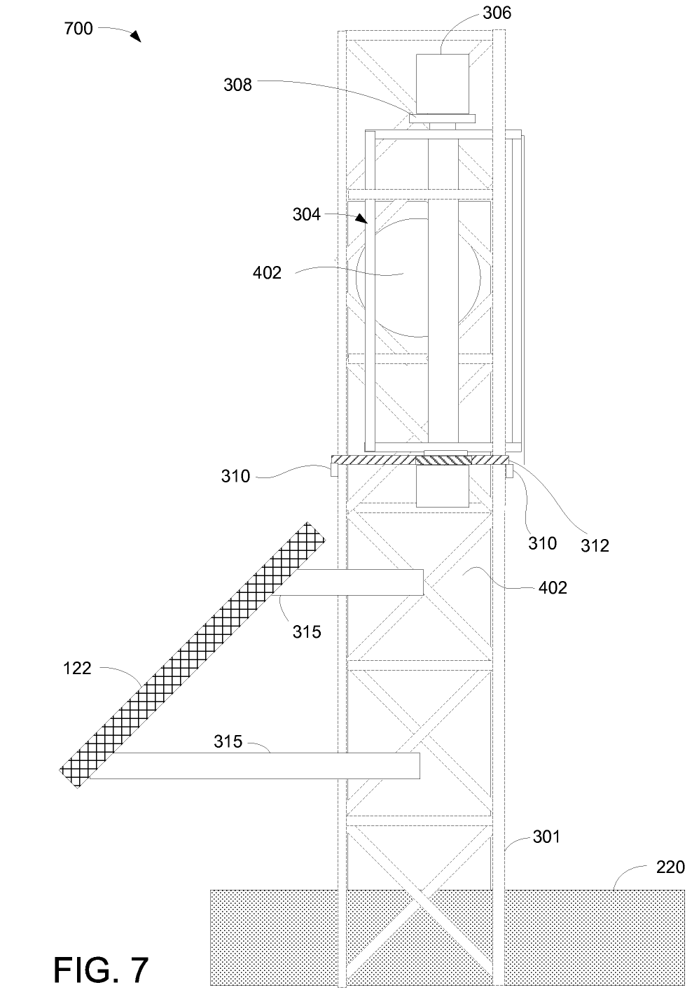

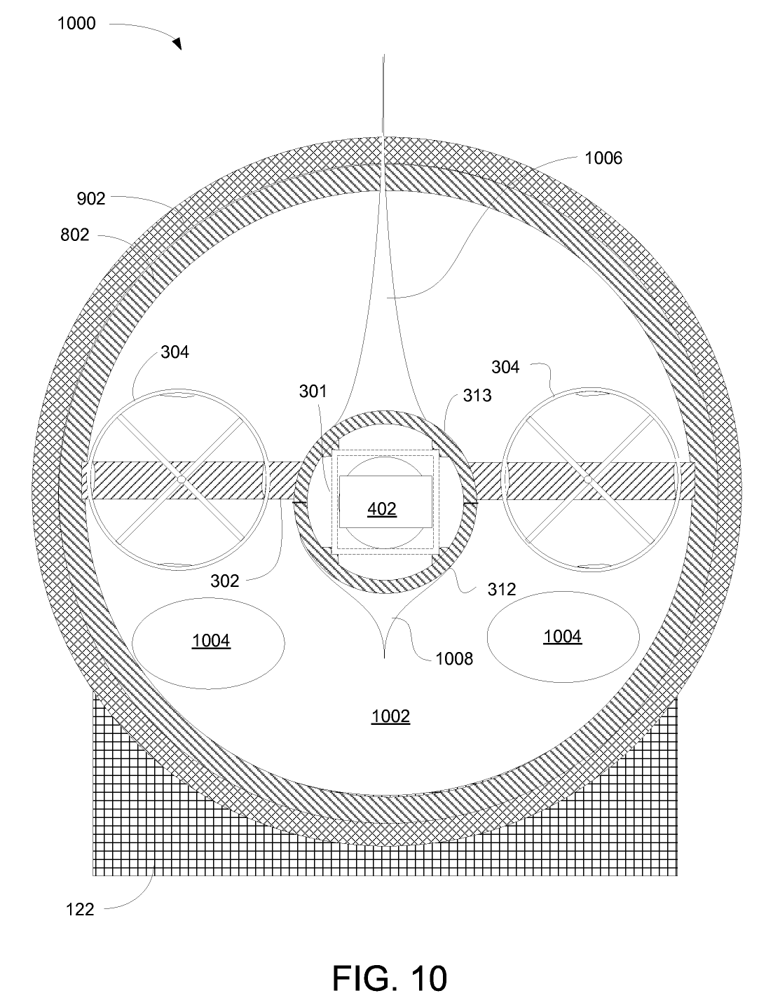

FIG. 8 is a top plan view illustrating an exemplary embodiment of a detail 800 of the hybrid co-generation energy tower 700 of FIG. 2, according to the present invention. FIG. 8 shows the addition of a ducting support ring 802, which is supported by struts (see FIG. 11) extending from the tower 301. Ducting support ring 802 is fixed to struts 1102, see FIG. 11.

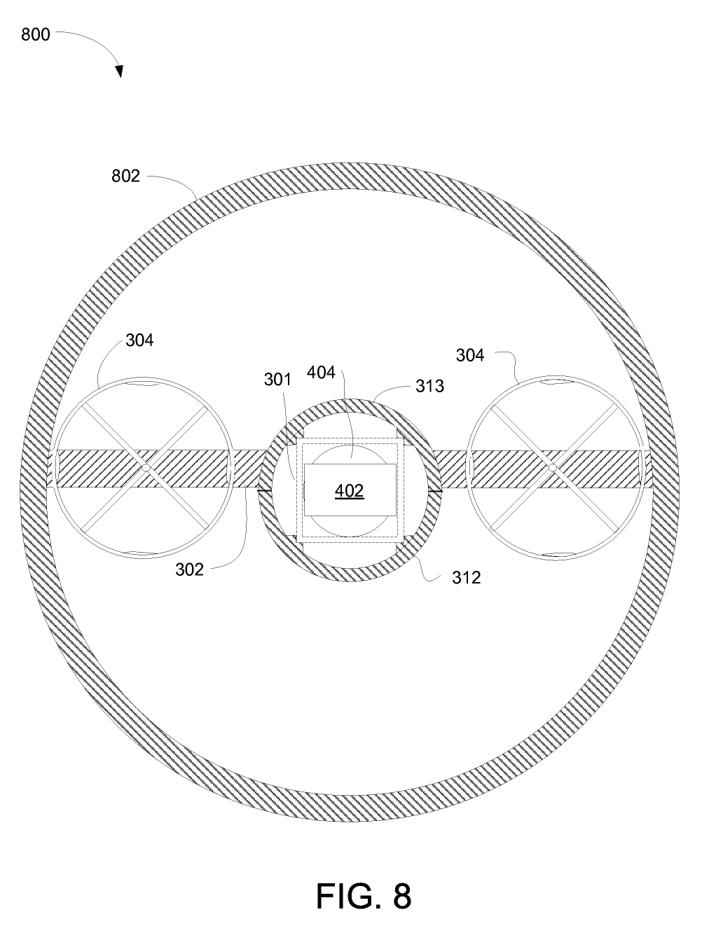

FIG. 9 is a front elevation view illustrating an exemplary embodiment of a detail 900 of the hybrid co-generation energy tower 700 of FIG. 2, according to the present invention. Ducting 902 is suspended from the ducting support ring 802 and functions to collect the waste heat, in the form of heated air, rising from the solar voltaic array 122.

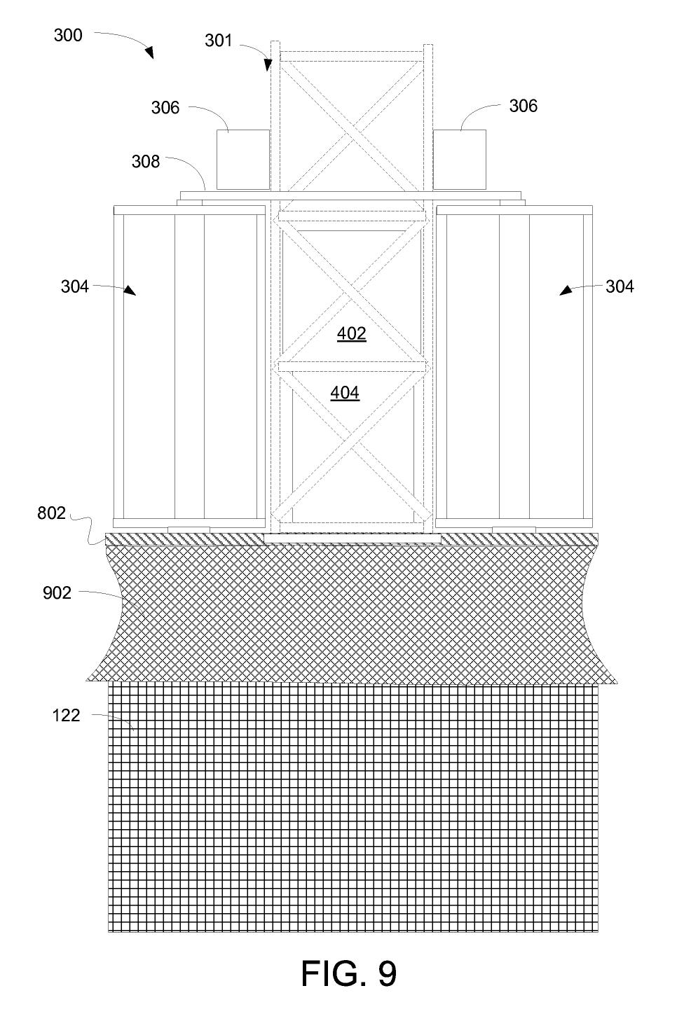

FIG. 10 is a top plan view illustrating an exemplary embodiment of a detail 1000 of the hybrid co-generation energy tower 700 of FIG. 2, according to the present invention. Disc 1002 captures the rising heated air from the solar voltaic array 122 and directs it to vents 1004. Vents 1004 may have directional cowlings to better direct the air flow to the VAWTs 304. Aerodynamic structure 1006 serves to keep the VAWTs facing the wind (from bottom of the page, as shown). Cowling 1008 reduces unsteady flow about the pole 301 proximate the VAWTs 304.

FIG. 11 is a side elevation view illustrating an exemplary embodiment of a detail 1100 of the hybrid co-generation energy tower 700 of FIG. 2B, according to the present invention. Hybrid co-generation energy tower 700 uses pole-mountable wind turbine support system 300 to extract waste heat from the solar-voltaic array 122 and genset 220. FIG. 11 shows a cross-section of the ducting 902, revealing the struts 1102 and the internal ducting 1104. Ducting 902 is preferably transparent, to avoid loss of solar power. The ducting 902 and 1104 form an annular duct that rotates with the VAWT support structure 300 but continues to collect the waste heated air flow from solar voltaic array 122. The strut 1102 distal the solar voltaic array may be releasable at the end proximate pole 301 and supportable by an extension to genset housing 220 for raising and lowering pole-mountable wind turbine support system 300.

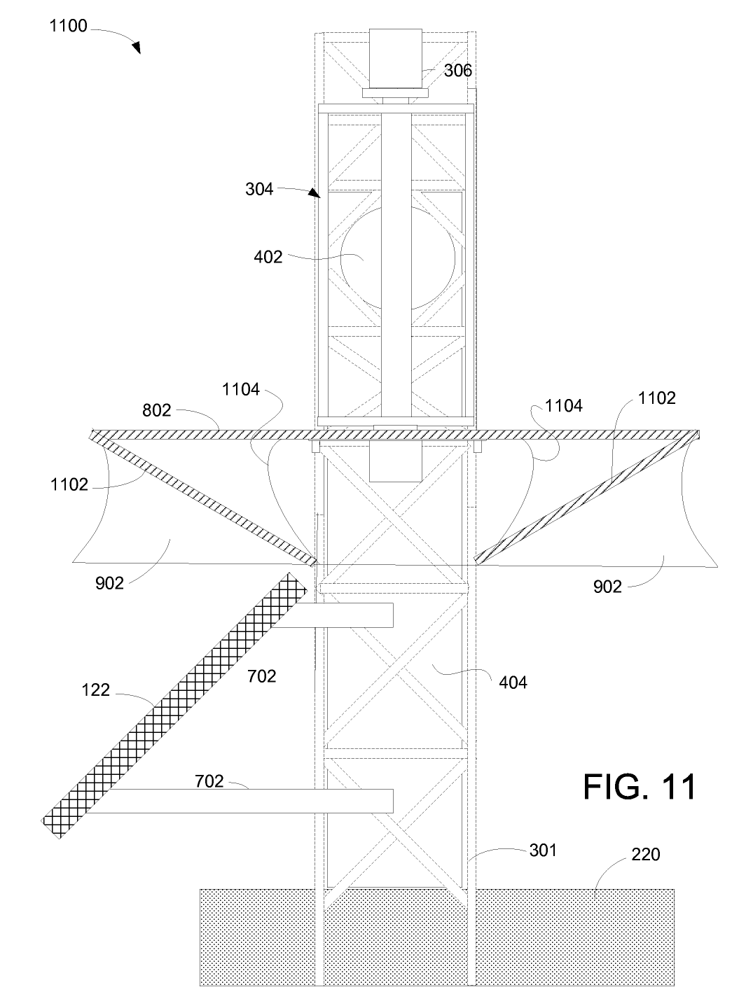

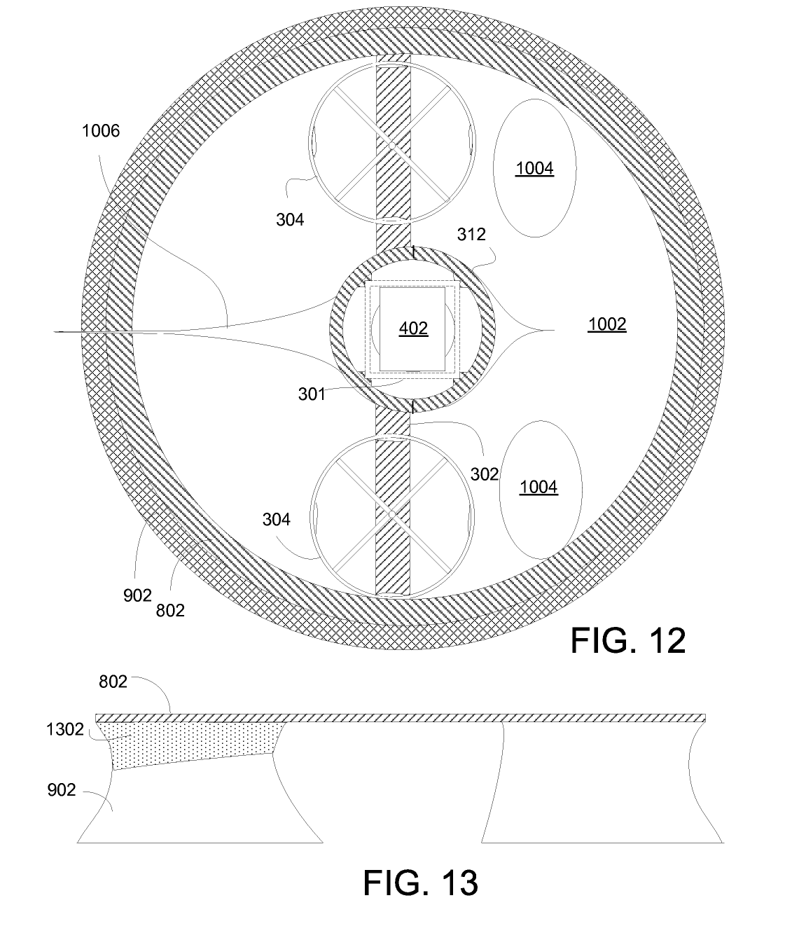

FIG. 12 is a top plan view illustrating an exemplary embodiment of a detail of the hybrid co-generation energy tower 700 of FIG. 2, according to the present invention. FIG. 12 is a portion of FIG. 10 turned at right angles to align with FIG. 13.

FIG. 13 is a side cross-sectional view illustrating an exemplary embodiment of a detail of the hybrid co-generation energy tower 700 of FIG. 2, according to the present invention. FIG. 13 shows sloped filler 1302 that functions to direct the rising hot air to the vents 1004.

FIG. 14 is a side elevation cutaway view illustrating an exemplary embodiment of a detail of a hybrid co-generation energy tower 700, according to the present invention. The tower 301, wind turbines 304, solar voltaic array 122, and primary ductwork 404 and 402 is substantially the same as for the embodiment of FIG. 11. The ducting 902 is shown in an alternative form. What is novel are the details of the cogeneration system. The genset housing 220 is elevated above a slab 1412 by feet 1410 and has a grated floor 1408 to allow air flow into the genset housing 220. The generator 1404 is driven through mechanical linkage 1403 by engine 1402, which together form the genset. The genset is mounted on genset carriage 1406 and is elevated above the carriage to enable cooling air flow over the genset. The engine 1402 is cooled using a horizontal radiator, or heat exchanger 1416 over which cooling air is driven by fan 1414. The airflow over the genset is entrained through venturi 1430, recovering about 8% of the waste heat of the engine 1402 and generator 1404. In a particular embodiment, a flapper valve may be provided at ventur 1430 to prevent backflow in unusual weather and/or maintenance conditions. The exhaust from the engine 1402 is expelled through insulated muffler 1418 into ductwork 404, thereby recovering waste heat and kinetic energy from the exhaust. Insulated muffler 1418 shares the upper housing 1420 with electrical equipment (to be discussed below), but is isolated from the electrical equipment by steel bulkhead 1430. Upper housing 1420 is preferably, like the genset housing 220, a forty-foot-long ISO container. The AC output of the generator 1404 is coupled to cogeneration controller 1424 by power conduit 1422.

UPS 199 is housed in the upper housing 1420, and receives DC power from the solar voltaic array 122 through power conduit 131 and from wind turbine generators 305 along power conduit 133. UPS 199 receives AC power through reverse feed switch 114 along power conduit 115. Reverse feed switch 114 receives utility grid power 112 along power lines 111. The remaining connections to reverse feed switch 114 are omitted in this drawing, for simplicity. The UPS 199 preferably has a UPS core having an AC input, an AC-DC converter, a multi-port DC bus, a DC-AC inverter, and at least one rapidly responsive energy storage device coupled to the multi-port DC bus, as shown in U.S. Pat. No. 7,411,308 to the present inventor, and which is incorporated herein by reference in its entirety. The DC output of UPS 199 may be used for supplying lamp 1428 (preferably a LED lamp) or other DC-powered device, along DC power conduit 1429. Other external DC loads may be supplied from UPS 199, as previously discussed. The AC output of UPS 199 is supplied to cogeneration controller 1424. Cogeneration controller 1424 is used to determine how much power is used from the generator 1404 and how much is used from UPS 199. The controller may be preset or may be made adaptive to system variables.

Those of skill in the art, informed by this disclosure, will appreciate the variations of this embodiment that may be made. For example, in an embodiment in which the amount of land is critical, the housings 220 and 1420 may be redesigned to be mounted vertically. Likewise, those wishing to power generator 1402 with hydrogen (or just produce hydrogen) may add an additional housing for the hydrogen generating and handling features described in co-pending Utility patent application Ser. No. 12/124,883 to the same inventor for RENEWABLE ENERGY POWER SYSTEMS. In a particular embodiment, the DC loads supplied from UPS 199 may be independent of facility needs.

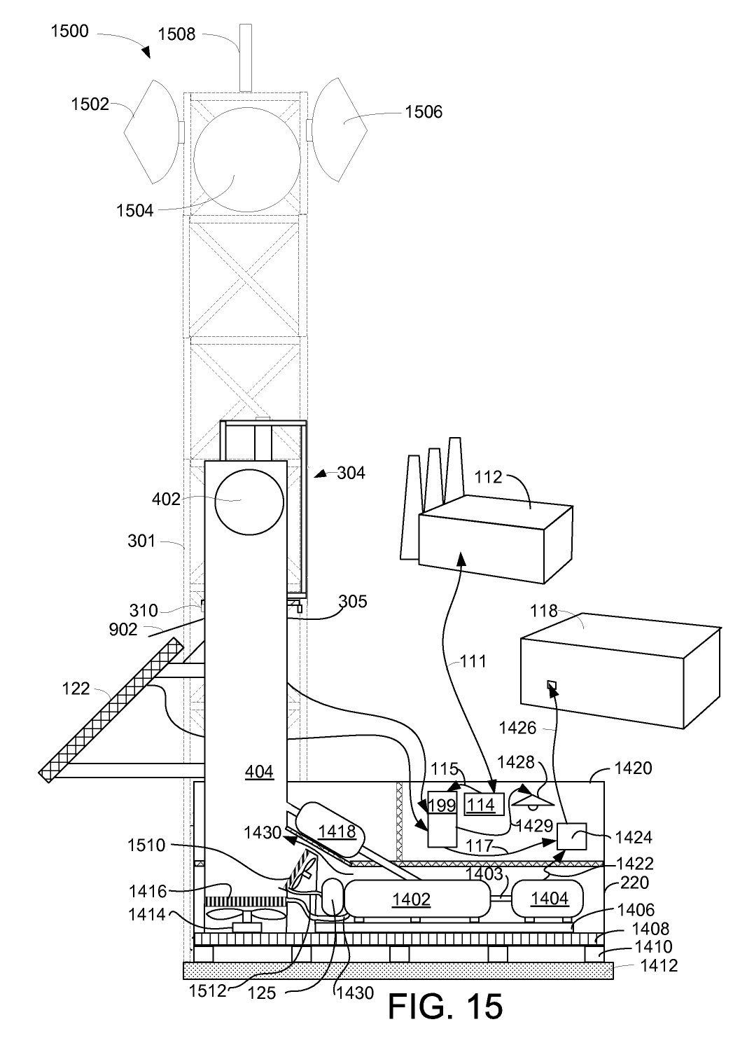

FIG. 15 is a side elevation cutaway view further illustrating the exemplary embodiment 1500 of details of a hybrid co-generation energy tower 700 of FIG. 7, according to the present invention. The tower 301 used for the renewable energy systems discussed above may also serve other purposes. For example, tower 301 may also be used as a communications tower, supporting various radio frequency antennas 1508 and microwave relay antennas 1502, 1504, and 1506. Other antennas, such as, without limitation, cell phone tower antennas, police band antennas, and fire band antennas, may be employed. In a particular embodiment, the antenna may include a radar antenna, with the entire embodiment configured as a remote radar installation. The possibilities for varied applications are vast, and are not limited to exemplary embodiments described here.

FIG. 15 also includes a CNG 4-stage compressor 125 and a heat exchanger 1510, which diagrammatically represents the intercoolers of the 4-stage compressor 125, while the thermal conduit 1512 diagrammatically represents the coupling of the heat to the heat exchanger 1510. The hydrogen production and handling features described in Utility Patent Serial No. 7,411,208 to the same inventor for RENEWABLE ENERGY POWER SYSTEMS are included by reference in embodiment 1500, but are not shown. The flow rates between heat exchanger 1416 and 1510 are controlled to prevent either from forcing backflow through the other. A flapper valve at venturi 1430 may be required to prevent backflow of heat exchanger 1510 and 1416 output.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A pole-mountable wind turbine support system comprising:
a) a plurality of wind turbines;
b) a support, operable to support said plurality of wind turbines on a vertical pole,
c) wherein at least a portion of said support is further operable to raise and lower said plurality of wind turbines on said vertical pole.

2. The pole-mountable wind turbine support system of claim 1, further comprising a plurality of electrical generators, corresponding to said plurality of wind turbines, coupled to said plurality of wind turbines and operable to produce electricity responsive to rotation of at least one wind turbine of said plurality of wind turbines.

3. The pole-mountable wind turbine support system of claim 1, wherein said support comprises a support ring, wherein said support ring comprises first and second half-rings operable to be releasably connected to form said support ring.

4. The pole-mountable wind turbine support system of claim 3, wherein said first half-ring has a fixed vertical position on said pole and has rotational freedom of motion about a vertical axis of said pole.

5. The pole-mountable wind turbine support system of claim 3, wherein said second half-ring is operable to:
a) move vertically on said pole; and
b) move said plurality of pole-mountable wind turbines rotationally about said pole, responsive to changes in wind direction.

6. The pole-mountable wind turbine support system of claim 1, further comprising:
a) at least one solar voltaic array fixed to a first side of said pole;
b) ductwork for directing air bearing waste heat from said at least one solar voltaic array, wherein said air bearing said waste heat is ducted to assist in driving said plurality of wind turbines;
c) wherein said second half-ring is operable to move said plurality of wind turbines above or below said at least one solar voltaic array on a second side of said pole.

7. The pole-mountable wind turbine support system of claim 1, further comprising vertical actuators operable to move at least a portion of said support vertically on said pole.

8. The pole-mountable wind turbine support system of claim 1, further comprising:
a) an engine-generator set for producing electricity and heat, wherein said heat comprises heat from an engine cooling system, heat from engine exhaust gases, and heat from convection cooling of said engine-generator set;
b) a heat exchanger for transferring at least a portion of said heat to an air stream; and
c) ductwork for directing said heated airstream to drive said plurality of wind turbines.

9. The pole-mountable wind turbine support system of claim 8, further comprising:
a) at least one solar voltaic array fixed to a first side of said pole;
b) ductwork for directing air bearing waste heat from said at least one solar voltaic array, wherein said air bearing said waste heat is ducted to assist in driving said plurality of wind turbines;
c) wherein said second half-ring is operable to move said plurality of wind turbines above or below said at least one voltaic array on a second side of said pole.

10. The pole-mountable wind turbine support system of claim 9, wherein electric power from said engine-generator set, electric power from said solar voltaic array, and electric power from said plurality of wind turbines is combined on a common DC bus in a UPS, wherein said DC bus has at least one DC output coupling.

11. The pole-mountable wind turbine support system of claim 10, wherein said combined electrical power is provided to a reverse feed switch and to a primary load, wherein said reverse feed switch is operable to transfer at least a portion of said combined electrical power to a commercial electrical power grid when said primary load does not consume all of said combined electrical power.

12. The pole-mountable wind turbine support system of claim 11, wherein said reverse feed switch comprises a portion of at least one parking lot solar power system, said at least one parking lot solar power system further comprising:
a) a parking lot;
b) a roof for providing shaded parking for at least one vehicle, said roof supported above at least a portion of said parking lot;
c) at least one solar voltaic array mounted on said roof;
d) a housing operable to support and assist in protecting:
i. a UPS core having an AC input, an AC-DC converter, a multi-port DC bus, and a DC-AC inverter;
ii. said reverse feed switch electrically coupled to said DC-AC inverter and to said commercial electrical power grid;
iii. a backup AC generator electrically coupled to said primary load and to said reverse feed switch; and
iv. at least one rapidly responsive energy storage device coupled to said multi-port DC bus;
e) a power conduit from said at least one solar voltaic array to an external DC input coupling on said multi-port DC bus; and
f) a power conduit from an external DC output coupling on said multi-port DC bus, operable to assist in coupling said multi-port DC bus to said at least one automotive charging station.

13. A pole-mountable wind turbine support system comprising:
a) a plurality of wind turbines mechanically coupled to a corresponding plurality of electrical power generators;
b) a support, operable to support said plurality of wind turbines on a vertical pole, said support comprising a ring surrounding said pole, said ring further comprising first and second half-rings that are releasably connectable together; and
c) wherein:
i. said first half-ring maintains a fixed vertical position on said pole and is rotatable about a vertical axis of said vertical pole; and
ii. second half-ring is operable to raise and lower said plurality of wind turbines on said vertical pole and, when connected to said first ring, is rotatable about said vertical axis of said vertical pole.

14. The pole-mountable wind turbine support system of claim 13, further comprising:
a) a plurality of additional electrical energy producers coupled to said pole;
b) at least one heat exchanger for exchanging waste heat from said additional electrical energy producers to an air stream;
c) at least one ductwork, operable to conduct said heated air stream to assist in driving said plurality of wind turbines.

15. The pole-mountable wind turbine support system of claim 14, further comprising:
a) a UPS having a multi-port DC bus operable to combine electrical power from said plurality of electrical energy producers and to provide a DC output coupling;
b) a plurality of electrical loads coupled to said combined electrical power;
c) at least one reverse feed switch operable to provide combined electrical power to a commercial electrical power grid when other electrical loads do not require it.

16. The pole-mountable wind turbine support system of claim 15, wherein a load of said plurality of loads comprises at least one parking lot solar power system acting as an electrical load when solar power is not available.

17. The pole-mountable wind turbine support system of claim 15, wherein said plurality of electrical energy producers comprises a solar voltaic array and an engine-generator set.

18. The pole-mountable wind turbine support system of claim 13, further comprising an aerodynamic structure to assist in maintaining said plurality of wind turbines in air flows of approximately equal velocity.

19. The pole-mountable wind turbine support system of claim 13 wherein said plurality of wind turbines comprises first and second vertical-axis wind turbines having opposite rotational directions.

20. A pole-mountable wind turbine support system comprising:
a) first and second vertical-axis wind turbines mechanically coupled to corresponding first and second electrical power generators;
b) a support, operable to support said first and second wind turbines astride a vertical pole, said support comprising a ring surrounding said pole, said ring further comprising first and second half-rings that are releasably connectable together,
c) wherein:
i. said first half-ring maintains a fixed vertical position on said pole and is rotatable about a vertical axis of said vertical pole; and
ii. second half-ring is operable to raise and lower said plurality of wind turbines on said vertical pole and, when connected to said first ring, is rotatable about said vertical axis of said vertical pole;
d) ductwork operable to conduct a stream of heated air to assist in driving said first and second wind turbines;
e) at least one heat exchanger operable to heat said stream of heated air from waste heat generated by at least one electrical power source; and
f) a UPS having a multiport bus operable to combine electrical power from said at least one electrical power source with electrical power generated by said electrical power generators mechanically coupled to said first and second wind turbines.
